(19) United States
(12) Patent Application Publication
(10) Pub. No.: US 2025/0317662 A1
(43) Pub. Date: Oct. 9, 2025

(54) SENSOR DEVICE

(71) Applicant: Sony Semiconductor Solutions Corporation, Kanagawa (JP)

(72) Inventor: Kazutoshi Kodama, Tokyo (JP)

(21) Appl. No.: 18/864,729

(22) PCT Filed: Jun. 14, 2023
(86) PCT No.: PCT/JP23/22007

§ 371 Date: Nov. 11, 2024

(30) Foreign Application Priority Data
Jun. 28, 2022 (JP) 2022-104009

(51) Int. Cl. H04N 25/60; H04N 25/47; H04N 25/707

(52) U.S. Cl. CPC H04N 25/60; H04N 25/47; H04N 25/707

(57) ABSTRACT

Sensor devices with dummy and event detection pixels are disclosed. In one example, a sensor device includes a pixel array with a dummy pixel that does not receive incident light, a gradation pixel including a sub-gradation pixel that receives incident light to acquire gradation information, and an event detection pixel including the sub-gradation pixel and a sub-event detection pixel that detects a change in the gradation information acquired by receiving incident light. The dummy pixel, the gradation pixel, and the event detection pixel are arranged in an array in a line direction and a column direction, and a signal is acquired by accessing simultaneously the sub-gradation pixel and the dummy pixel belonging to a line different from a line to which the sub-gradation pixel belongs.

### TECHNICAL FIELD

The present disclosure relates to a sensor device.

### BACKGROUND ART

Image sensors are used in a wide range of fields. Pixels in such an image sensor are configured to acquire gradation information. Today, there are some configurations where the pixels that acquire the gradation information and pixels that acquire event detection information are both provided. Furthermore, a sensor using a charge coupled device (CCD) or a complementary metal oxide semiconductor (CMOS) performs processing such as noise reduction on the basis of output from optical black corresponding to pixels that does not receive light.

As a method for reducing horizontal streaks in an image by reflecting output from optical black in a column direction in output from effective pixels, there is a method in which, with analog to digital converters (ADCs) separately arranged in the column direction, the output value of the optical black is subtracted from the output value of the effective pixels to acquire a pixel value. In such a configuration where event detection pixels and gradation pixels are both provided, in a case where an event is detected in the event detection pixel, there is a possibility that a voltage greatly fluctuates, and there is a possibility that signal deviation in gradation signal occurs due to signal interference between the event detection pixel that has detected the event and a signal line dedicated to the optical black.

### CITATION LIST

### Patent Document

Patent Document 1: Japanese Patent Application Laid-Open No. 2020-161992
Patent Document 2: Japanese Patent Application Laid-Open No. 2011-040807

### SUMMARY OF THE INVENTION

### Problems to be Solved by the Invention

It is therefore an object of the present disclosure to provide a sensor device in which a dummy pixel, a gradation pixel, and an event detection pixels are appropriately arranged and connected.

### Solutions to Problems

According to an embodiment, the sensor device includes a pixel array. The pixel array includes a dummy pixel that does not receive incident light, a gradation pixel including a sub-gradation pixel that receives incident light to acquire gradation information, and an event detection pixel including the sub-gradation pixel and a sub-event detection pixel that detects a change in the gradation information acquired by receiving incident light, the dummy pixel, the gradation pixel, and the event detection pixel being arranged in an array in a line direction and a column direction, and a signal is acquired by accessing simultaneously the sub-gradation pixel and the dummy pixel belonging to a line different from a line to which the sub-gradation pixel belongs.

The pixel array may include a first dummy region in which the dummy pixel is arranged, and a light receiving region in which the gradation pixel and the event detection pixel are arranged.

The dummy pixel may include a light shielding pixel corresponding to the gradation pixel having a light receiving surface shielded from light or the event detection pixel having a light receiving surface shielded from light.

The first dummy region may be provided on an edge of the pixel array at least along the line direction.

The dummy pixel arranged in the first dummy region and the event detection sub-pixel belonging to the light receiving region may perform output for each column through the same signal line.

The dummy pixel may include a pixel that is arranged in the first dummy region in an arrangement configuration different from an arrangement configuration of the gradation pixel and the event detection pixel in the light receiving region and is shielded from light.

The dummy pixel need not include a sub-pixel corresponding to the sub-event detection pixel of the event detection pixel shielded from light.

The pixel array may include a plurality of the gradation pixels and a plurality of the event detection pixels, which sub-pixel of each of the pixels acquires and outputs a signal may be switched in response to a trigger signal, and no connection may be established to the dummy pixel corresponding to the sub-event detection pixel shielded from light in response to the trigger signal.

A plurality of column signal lines through which a signal output from a pixel belonging to one of the columns propagates may be further included, and one of the plurality of column signal lines may be connected exclusively to the dummy pixel.

In a unit pixel group including two pixels arranged contiguous in the line direction and a plurality of pixels arranged contiguous in the column direction, a plurality of column signal lines through which a signal output from the unit pixel group belonging to the column direction propagates may be further included, and pixels that belong to the same line and are identical in position in the unit pixel group may be connected to the column signal lines provided at the same relative position among the plurality of column signal lines.

In a unit pixel group including two pixels arranged contiguous in the line direction and a plurality of pixels arranged contiguous in the column direction, a plurality of column signal lines through which a signal output from the unit pixel group belonging to the column direction propagates may be further included, and pixels that belong to the same line and are identical in position in the unit pixel group may be connected to the column signal lines provided at different relative positions among the plurality of column signal lines.

The unit pixel group may include eight pixels, the eight pixels including: two pixels arranged contiguous in the line direction; and four pixels arranged contiguous in the column direction.

In the line different from the first dummy region on the edge of the pixel array, a second dummy region including the dummy pixel corresponding to a pixel that is identical in configuration to a line in the light receiving region and is shielded from light may be further included, and a reference value used to correct a signal value output from a pixel belonging to the light receiving region may be calculated from a signal value output from the dummy pixel belonging to the second dummy region.

A signal value output from the first dummy region may be compared with the reference value, and a correction region corresponding to a pixel region for which a signal value output from the light receiving region is corrected may be acquired.

Gradation information in the correction region may be corrected on the basis of the signal value output from the first dummy region.

A third dummy region in which the dummy pixel is provided on the edge of the pixel array along the column direction so as not to overlap the first dummy region may be further included, and a reference value used to correct a signal value output from a pixel belonging to the light receiving region may be calculated from a signal value output from the dummy pixel belonging to the third dummy region.

A signal value output from the first dummy region may be compared with the reference value, and a correction region corresponding to a pixel region for which a signal value output from the light receiving region is corrected may be acquired.

Gradation information in the correction region may be corrected on the basis of the signal value output from the first dummy region.

The dummy pixel may include an analog dummy pixel that outputs a predetermined analog voltage.

### BRIEF DESCRIPTION OF DRAWINGS

FIG. 1 is a block diagram schematically illustrating a sensor device according to an embodiment.

FIG. 2 is a block diagram schematically illustrating an example of a first signal processing circuit according to an embodiment.

FIG. 3 is a diagram schematically illustrating a configuration example of a pixel according to an embodiment.

FIG. 4 is a diagram schematically illustrating a configuration example of a pixel according to an embodiment.

FIG. 5 is a diagram schematically illustrating a configuration example of a pixel according to an embodiment.

FIG. 6 is a diagram schematically illustrating a configuration example of a pixel according to an embodiment.

FIG. 7 is a diagram schematically illustrating a configuration example of a pixel according to an embodiment.

FIG. 8 is a diagram schematically illustrating a configuration example of a pixel array according to an embodiment.

FIG. 9 is a diagram schematically illustrating a configuration example of a pixel array according to an embodiment.

FIG. 10 is a diagram schematically illustrating a connection example between pixels and signal lines according to an embodiment.

FIG. 11 is a flowchart illustrating correction processing according to an embodiment.

FIG. 12 is a diagram schematically illustrating a connection example between pixels and signal lines according to an embodiment.

FIG. 13 is a diagram schematically illustrating a connection example between pixels and signal lines according to an embodiment.

FIG. 14 is a diagram schematically illustrating an example of a light shielding pixel according to an embodiment.

FIG. 15 is a diagram schematically illustrating an example of a light shielding pixel according to an embodiment.

FIG. 16 is a diagram schematically illustrating an example of a light shielding pixel according to an embodiment.

FIG. 17 is a block diagram illustrating an example of a schematic configuration of a vehicle control system.

FIG. 18 is a diagram of assistance in explaining an example of installation positions of an outside-vehicle information detecting section and an imaging section.

### MODE FOR CARRYING OUT THE INVENTION

The following is a description of embodiments of the present disclosure, given with reference to the drawings. The drawings are used for the description, and the shape and size of each component in actual devices, the ratios of size to other components, and the like are not necessarily as illustrated in the drawings. Furthermore, since the drawings are illustrated in a simplified manner, it should be understood that components necessary for implementation other than those illustrated in the drawings are provided as appropriate.

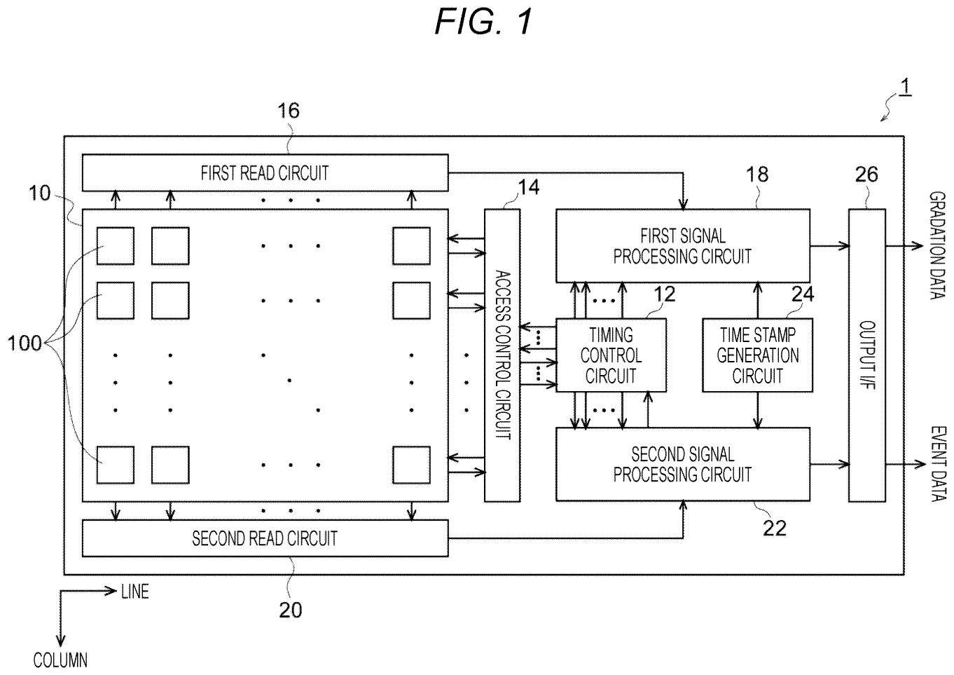

FIG. 1 is a block diagram schematically illustrating an example that is not limited to a sensor device according to an embodiment. The sensor device 1 includes a pixel array 10, a timing control circuit 12, an access control circuit 14, a first read circuit 16, a first signal processing circuit 18, a second read circuit 20, a second signal processing circuit 22, a time stamp generation circuit 24, and an output interface (hereinafter, referred to as output I/F 26). The sensor device 1 is provided in, for example, an electronic apparatus such as a solid-state imaging device.

The pixel array 10 includes a plurality of pixels 100. The pixels 100 are arranged in at least a plurality of columns (line direction). It is desirable that the pixels 100 be also arranged in at least a plurality of lines (column direction) and are thus arranged in a two-dimensional array.

The pixel array 10 includes at least a path through which a signal is output from each pixel 100 to a read circuit, a path through which, in a case where an event is detected in the pixel 100, the detection of the event is output to the access control circuit 14, or a path through which a signal indicating from which of the pixels 100 information is to be read is input from the access control circuit 14.

Each pixel 100 includes a light receiving element capable of acquiring gradation information. Each pixel 100 includes a pixel circuit that drives the light receiving element to appropriately acquire the output from the light receiving element. The pixel circuit may include, for example, either or both of a circuit that converts a signal acquired from the light receiving element into a signal indicating gradation information and outputs the resultant signal and a circuit that detects a change in the signal acquired from the light receiving element and converts the change into a signal indicating event detection information and outputs the resultant signal.

As an example, the pixel 100 may be fired as a circuit that outputs a signal indicating event detection information in a case where a difference in gradation value from the previous frame exceeds a predetermined value, and as another example, the pixel 100 may be fired in a case where a contrast ratio exceeds a threshold. Here, being fired indicates that an event has detected in the pixel 100.

Note that a detailed configuration of the pixel 100 in the present disclosure will be described later.

The timing control circuit 12 and the access control circuit 14 constitute a control circuit that controls timing of access to the pixel 100, timing of reading of a signal from the pixel 100, and timing of signal processing on the read signal. Furthermore, the control circuit may control output timing of the signal subjected to the signal processing.

For example, the timing control circuit 12 outputs a frame synchronization signal and a horizontal synchronization signal to the access control circuit 14 on the basis of an input clock signal. Furthermore, the timing control circuit 12 may generate timing at which the signal processing is performed on the basis of the signal corresponding to the firing state of the pixel 100 received from the access control circuit 14 and output the timing to the signal processing circuit.

The access control circuit 14 outputs an operation signal used to select a pixel 100 to be accessed on the basis of the horizontal synchronization signal acquired from the timing control circuit 12 to cause the pixel 100 to output event information to the second read circuit 20. That is, the event detection in the present disclosure is made by operating the pixel 100 for each frame on the basis of frame information output from the timing control circuit 12.

The first read circuit 16 converts an analog signal indicating the gradation information output from the pixel 100 into a digital signal. The first read circuit 16 outputs the digital signal obtained as a result of the conversion to the first signal processing circuit 18.

The first read circuit 16 may include an analog to digital converter (ADC) that converts an analog signal into a digital signal. The ADC may be a column ADC provided for each column or a pixel ADC provided for each pixel.

The first signal processing circuit 18 is a circuit that performs signal processing of converting acquired gradation information into appropriate image information. The first signal processing circuit 18 may perform, for example, at least one of linear matrix processing, filtering processing, image processing, or machine learning processing, and converts an input digital signal into an image signal and outputs the image signal. Furthermore, the first signal processing circuit 18 performs processing of correcting the gradation information on the basis of a reference value. The reference value will be described in detail later. The first signal processing circuit 18 outputs the processed signal as image data to the outside, such as a processor of an electronic apparatus provided outside, via the output I/F 26.

The second read circuit 20 appropriately converts the information acquired from the pixel 100 that detects the event information, and outputs the resultant information to the second signal processing circuit 22. The second read circuit 20 may operate as, for example, an analog front end (AFE). The second read circuit 20 may include a latch that temporarily stores the event detection information output from each pixel 100, for example, for each column.

The second signal processing circuit 22 converts the event information output from the second read circuit 20 on the basis of access information regarding the pixel 100 controlled by the access control circuit 14 acquired via the timing control circuit 12, and outputs the resultant event information as event data to the outside, such as a processor of an electronic apparatus provided outside, via the output I/F 26. The second signal processing circuit 22 may rearrange the acquired event information or format the event information as necessary and output the resultant event information. Furthermore, as described above, the second signal processing circuit 22 may perform the signal processing in synchronization with the timing generated by the timing control circuit 12 on the basis of the output of the access control circuit 14.

The time stamp generation circuit 24 outputs time stamp information, simply referred to as time information, for example, to the first signal processing circuit 18 and the second signal processing circuit 22. The first signal processing circuit 18 and the second signal processing circuit 22 add an appropriate time stamp to data and output the resultant data. As described above, it is possible to cause, by adding an appropriate time stamp, an external processor or the like to acquire the appropriate order of the time stamp of output data or the like and perform signal processing or the like.

The output I/F 26 is an interface that outputs the gradation information and the event detection information acquired and converted by the sensor device 1 to the outside. The output I/F 26 may be, for example, an interface such as MIPI (registered trademark). The sensor device 1 outputs the acquired event information to the outside via the output I/F 26.

With such a configuration, it is possible to appropriately control the access in the horizontal direction and the timing of the horizontal synchronization signal in accordance with the amount of data to be acquired.

This configuration allows the use of the same synchronization signal, particularly as the synchronization signal for the access control in the read circuit of the pixel array 10 and the signal processing control in the signal processing circuit. It is therefore possible to increase throughput in a case where the data output speed of the sensor device 1 is limited by a data bus.

Note that the timing control circuit 12 is not an essential component. For example, in a case where any one of the timing of accessing and reading the pixel 100 or the timing of data transfer from the read circuit to the signal processing circuit is invariable, the synchronization signal can be fixed, so that it is possible for the sensor device 1 to enable the operation of the sensor device 1 without the timing control circuit 12.

Furthermore, the sensor device 1 may include a frame memory (not illustrated). The frame memory is a memory capable of temporarily storing gradation information and event detection information for each frame.

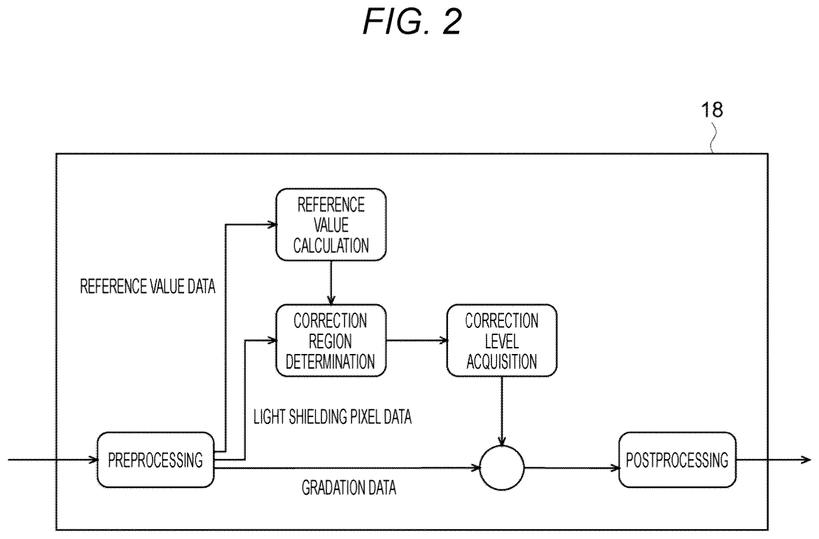

Next, how to correct the pixel value in the first signal processing circuit 18 will be described. FIG. 2 is a block diagram schematically illustrating an example of the first signal processing circuit 18.

The first signal processing circuit 18 can perform the signal processing on the basis of gradation data, light shielding pixel data, and reference value data acquired from the first read circuit 16. The gradation data is data acquired by the ADC. The light shielding pixel data is data output from the light shielding pixel (optical black) provided in the pixel array 10. The reference value data is data used to calculate the reference value. The light shielding pixel data and the reference value data will be described in detail later.

The first signal processing circuit 18 performs preprocessing on the input data. This preprocessing is processing of converting each piece of data into appropriate data. The preprocessing may include, for example, processing of subjecting the gradation data to linear matrix processing to calculate image data appropriately indicating the gradation value of each pixel.

The first signal processing circuit 18 calculates the reference value on the basis of the reference value data. Along with this processing, the first signal processing circuit 18 determines a region to be corrected on the basis of the light shielding pixel data. The first signal processing circuit 18 acquires, from information regarding the reference value and the correction region, a level at which the output from which pixel 100 is corrected, and corrects the gradation data in the correction region of the image data using the correction level on the basis of the information.

After this processing, the first signal processing circuit 18 performs various filtering processing and the like on the corrected image data and outputs the resultant image data. It is possible for the sensor device 1 to output, by performing such processing, the image data subjected to appropriate gradation processing.

Next, the arrangement of the pixels 100 in the pixel array 10 and the arrangement of the signal lines through which signals are output from the pixels 100 will be described. In the present disclosure, the arrangement of the pixels 100 in the pixel array 10 and the connection of the signal lines provided for each column in the pixel arrangement will be described in detail.

The pixel array 10 includes dummy pixels, gradation pixels, and event detection pixels arranged in an array in the line direction and the column direction, the dummy pixels being configured not to receive incident light, the gradation pixels being configured to receive incident light and output gradation information, the event detection pixels being configured to receive incident light and output gradation information or detect a change in the gradation information and output event detection information. Such pixels include a plurality of sub-pixels.

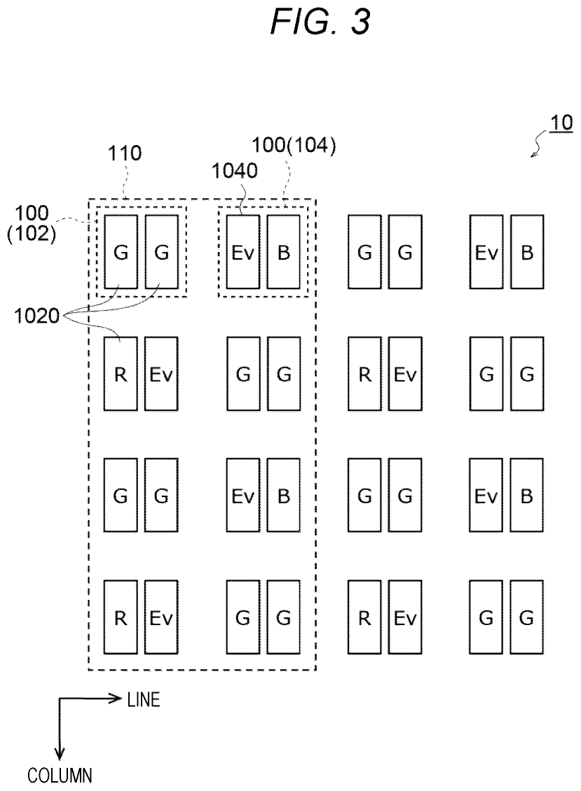

FIG. 3 is a diagram schematically illustrating an unrestricted example of a pixel configuration. In a light receiving region of the pixel array 10, a plurality of pixels 100 is arranged in an array. Each pixel 100 indicated by a dotted line includes a plurality of sub-pixels. The sub-pixels include, for example, a sub-gradation pixel 1020 and a sub-event detection pixel 1040.

The sub-gradation pixel 1020 is a sub-pixel that outputs, as gradation information, an analog signal obtained as a result of photoelectrical conversion in the light receiving element via a pixel circuit. The pixel circuit that outputs the analog signal obtained as a result of photoelectrical conversion as the gradation information may be any circuit that outputs the gradation information as an analog signal. R, G, and B illustrated in the sub-gradation pixel 1020 each denote a color of light to be received. The sub-gradation pixels 1020 denoted by R, G, and B include elements such as photodiodes that appropriately receive light in the red wavelength region, light in the green wavelength region, and light in the blue wavelength region, respectively.

The sub-event detection pixel 1040 is a sub-pixel denoted by Ev. The sub-event detection pixel 1040 is a sub-pixel that outputs a change in gradation information, which is an analog signal obtained as a result of photoelectrical conversion in the light receiving element, via a pixel circuit. The pixel circuit that outputs the event detection information from the analog signal obtained as a result of photoelectrical conversion may be any circuit as long as the circuit outputs the event detection information as an analog signal.

The sub-gradation pixel 1020 and the sub-event detection pixel 1040 form a gradation pixel 102 and an event detection pixels 104.

The gradation pixel 102 may have all of its sub-pixels as the sub-gradation pixels 1020. With this configuration, the gradation pixel 102 outputs gradation information at any timing.

The event detection pixel 104 may have some of its sub-pixels, for example, sub-pixels belonging to a half region of all of its sub-pixels as the sub-event detection pixels 1040, and have other sub-pixels as the sub-gradation pixels 1020. With this configuration, whether the event detection pixel 104 outputs the gradation information or the event detection information is controlled according to timing.

The pixel 100 sequentially connects the plurality of sub-pixels to output the gradation information or the event detection information at appropriate timing. As an example, the pixels 100 belonging to the same line of the pixel array 10 may each access a sub-pixel located at the same relative position in the pixel at the same timing.

For example, in FIG. 3, a sub-gradation pixel 1020 on the left side of the green gradation pixel 102, a sub-event detection pixel 104 on the left side of the blue event detection pixel 104, and a sub-gradation pixel 1020 on the left side of the red event detection pixel 104 may be driven at the same timing to acquire their respective gradation signals or event detection signals.

According to the above-described access example, it is possible to acquire appropriate gradation information and achieve highly accurate event detection.

As an example, a unit pixel group is set as indicated by a dashed line in the drawing. An appropriate path may be established for each unit pixel group via a signal line extending in the column direction. The unit pixel group may be, for example, a set of 2×4 pixels of two pixels arranged contiguous in the line direction and four pixels arranged contiguous in the column direction. This connection will be described later with a specific example.

Note that, in FIG. 3, the color arrangement of the gradation pixels 102 and the event detection pixels 104 is, but not limited to, the Bayer arrangement. For example, a complementary color such as cyan, yellow, or magenta may be included as at least some of the pixels, or a pixel that receives white light may be included. In addition, a pixel that receives infrared light, another multispectral pixel, a pixel including a plasmon filter, or the like may be provided. Furthermore, although the configuration where the G pixel 100 includes no sub-event detection pixel 1040 is illustrated, the pixel configuration is not limited to such a configuration, and the G pixel 100 may be configured as an event detection pixel 104 including the sub-event detection pixel 1040.

Furthermore, a configuration where, not limited to the event detection pixel, but, for example, an avalanche photo diode (APD) or a single photon avalanche diode (SPAD) is provided to acquire time of flight (ToF) information or depth information instead of event detection may be employed.

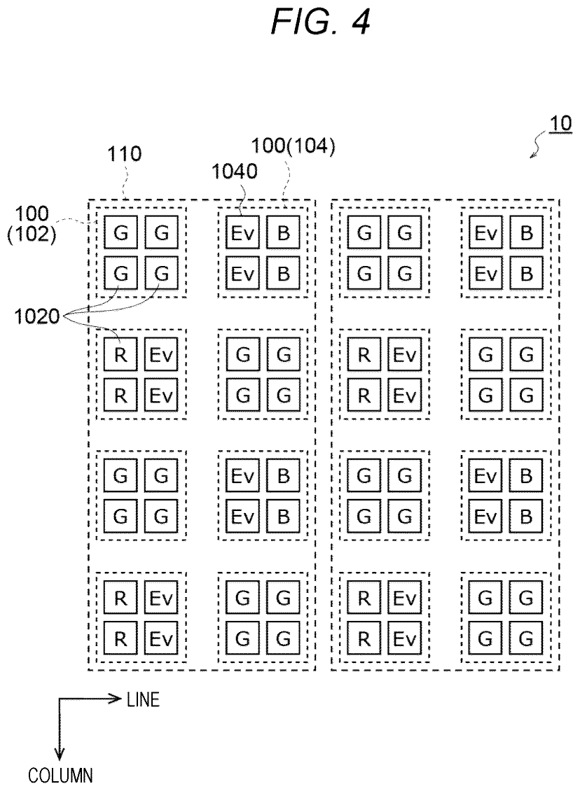

FIG. 4 is a diagram illustrating another configuration example of the pixel 100. As illustrated in FIG. 4, each pixel 100 may include four sub-pixels. Also with this configuration, in the gradation pixel 102 and the event detection pixel 104, sub-pixels located at the same relative position can be accessed at the same timing.

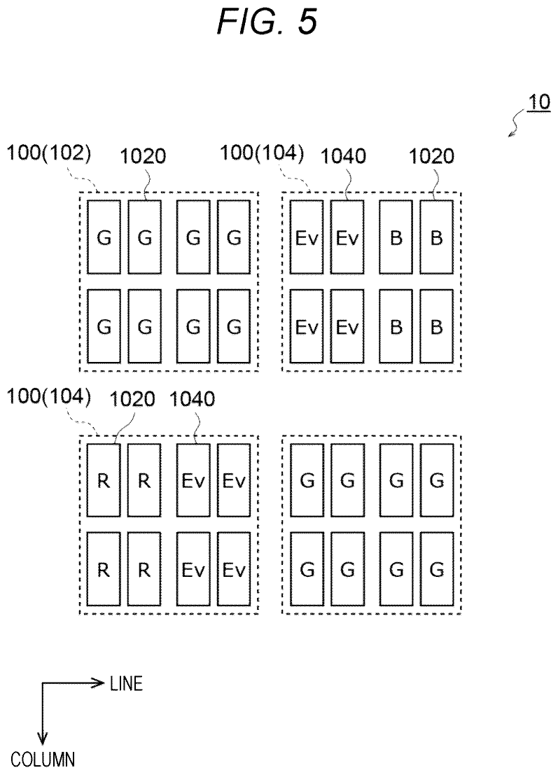

FIG. 5 is a diagram illustrating still another configuration example of the pixel 100. As illustrated in FIG. 5, each pixel 100 may include eight sub-pixels. The gradation pixel 102 includes, for example, eight sub-gradation pixels 1020. The event detection pixel 104 includes, for example, four sub-event detection pixels 1040 and four sub-gradation pixels 1020. Although not illustrated in the drawing, the unit pixel group may be defined as a set of eight pixels as in FIGS. 3 and 4. Even in a case where the pixel 100 includes four sub-pixels or eight sub-pixels, the sub-pixels to be accessed at the same timing may be controlled on the basis of their respective relative positions in the pixel 100.

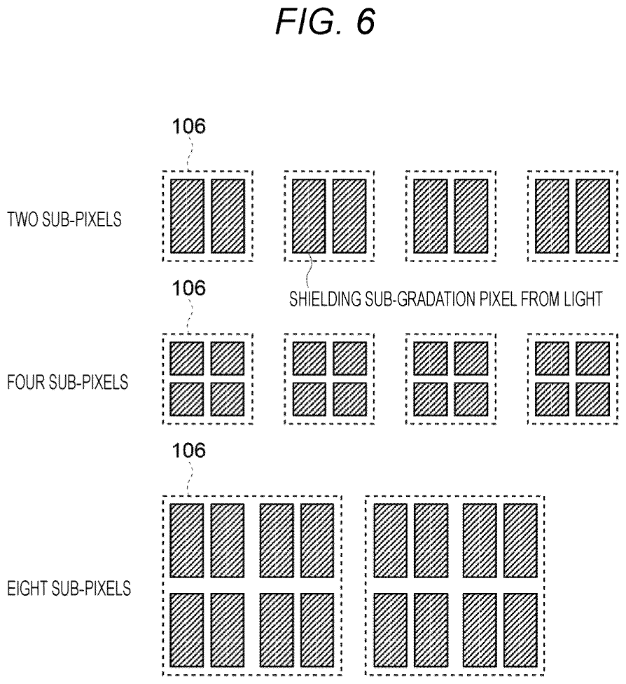

FIG. 6 is a diagram illustrating a configuration example of the dummy pixel (light shielding pixel). As an example, the light shielding pixel 106 includes the same number of sub-pixels as the number of divisions illustrated in FIG. 3, 4, or 5. FIG. 6 is a top view of an example of the pixel array 10 as viewed from a direction in which light is incident. A pixel 100 including two sub-pixels, a pixel 100 including four sub-pixels, and a pixel 100 including eight sub-pixels are illustrated in this order from the top.

A sub-pixel indicated as diagonal lines extending from bottom left to top right and included in the light shielding pixel 106 is a sub-light shielding pixel corresponding to a sub-gradation pixel 1020 having the light receiving surface shielded from light. As illustrated in FIG. 6, the light shielding pixel may include a sub-light shielding pixel corresponding to the sub-gradation pixel 1020 having the light receiving surface shielded from light.

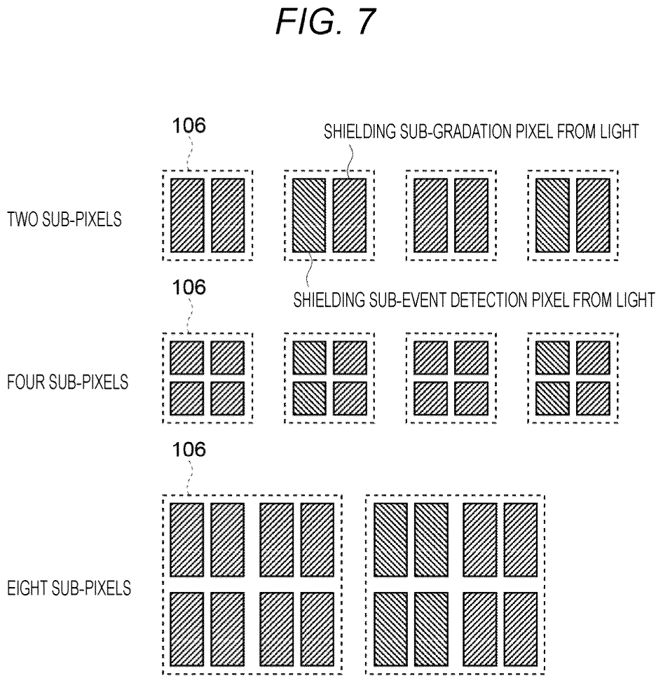

FIG. 7 is a diagram illustrating another configuration example of the light shielding pixel. A sub-pixel indicated by diagonal lines extending from bottom right to top left and included in the light shielding pixel 106 is a sub-light shielding pixel corresponding to a sub-event detection pixel 1040 having the light receiving surface shielded from light. As described above, the light shielding pixel 106 may include sub-light shielding pixels corresponding to the sub-gradation pixel 1020 having the light receiving surface shielded from light and the sub-event detection pixel 1040 having the light receiving surface shielded from light, in a manner similar to the arrangement of other pixels in the pixel array 10.

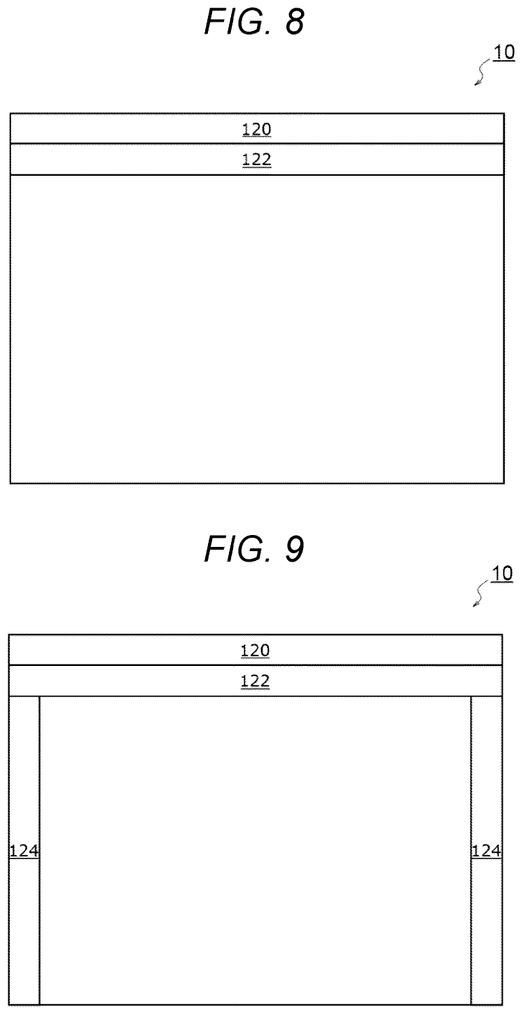

FIG. 8 is a diagram illustrating a light receiving pixel region and a dummy region in the pixel array 10. The dummy region in which the light shielding pixels 106 are provided over a line on the edge of the pixel array 10, for example. Each dummy region includes, for example, a plurality of lines, and a pixel in the dummy region is formed as the light shielding pixel 106 having the light receiving surface shielded from light. The pixel array 10 includes, for example, a first dummy region 120, a second dummy region 122, and the light receiving region as the other region.

The first dummy region 120 is a region including a light shielding pixel 106 for calculating an influence such as signal interference between signal lines and pixels for an image formed on the basis of signals acquired in the light receiving region of the pixel array 10. In the first dummy region 120, for example, as illustrated in FIG. 7, the light shielding pixel 106 different in configuration from the pixel in the light receiving region may be provided.

The second dummy region 122 is a region including a light shielding pixel 106 that outputs data used to calculate a reference value, the reference value being used to correct, on the basis of a dark portion signal, a gradation value of signals acquired in the light receiving region of the pixel array 10. In the second dummy region 124, for example, as illustrated in FIG. 6, the light shielding pixel 106 identical in configuration to the pixel in the light receiving region may be provided. The light shielding pixel 106 provided in the second dummy region 122 operates in a manner similar to so-called optical black in a general sense.

FIG. 9 is a diagram illustrating another example of the light receiving pixel region and the dummy region of the pixel array 10. The dummy region including the light shielding pixel 106 may include, for example, the first dummy region 120 and the second dummy region 122 provided over lines, and a third dummy region 124 provided over a column on the edge of the pixel array 10.

The third dummy region 124 is a region in which the light shielding pixel 106 are provided over a column on the edge of the pixel array 10. Although provided on the left and right sides in FIG. 9, the third dummy region 124 may be provided on any one of the left and right edges. Furthermore, the arrangement configuration of the light shielding pixels 106 provided in the third dummy region 124 may be similar to, for example, the arrangement configuration of the pixels 100 in the light receiving region as illustrated in FIG. 6.

As illustrated in the drawing, the third dummy region 124 is arranged so as to overlap neither the first dummy region 120 nor the second dummy region 124. As another example, the third dummy region 124 may be defined as a region including all the light shielding pixels 106 belonging to the column direction in the pixel array 10, and the first dummy region 120 and the second dummy region 122 may be defined as regions extending along lines and not overlapping the third dummy region 124.

The third dummy region 124 may output data used to calculate the reference value instead of the second dummy region 122.

With the above-described configuration, the gradation pixel 102 is accessed at the same timing as the light shielding pixel 106 belonging to any dummy region, and a signal is then acquired. The gradation pixel 102 and the light shielding pixel 106 may be pixels belonging to the same column. That is, in the sensor device 1, for example, the gradation pixel 102 and the light shielding pixel 106 that belong to the same column but belong to different lines may be driven at the same timing to output signals.

The connection between pixels and signal lines will be described.

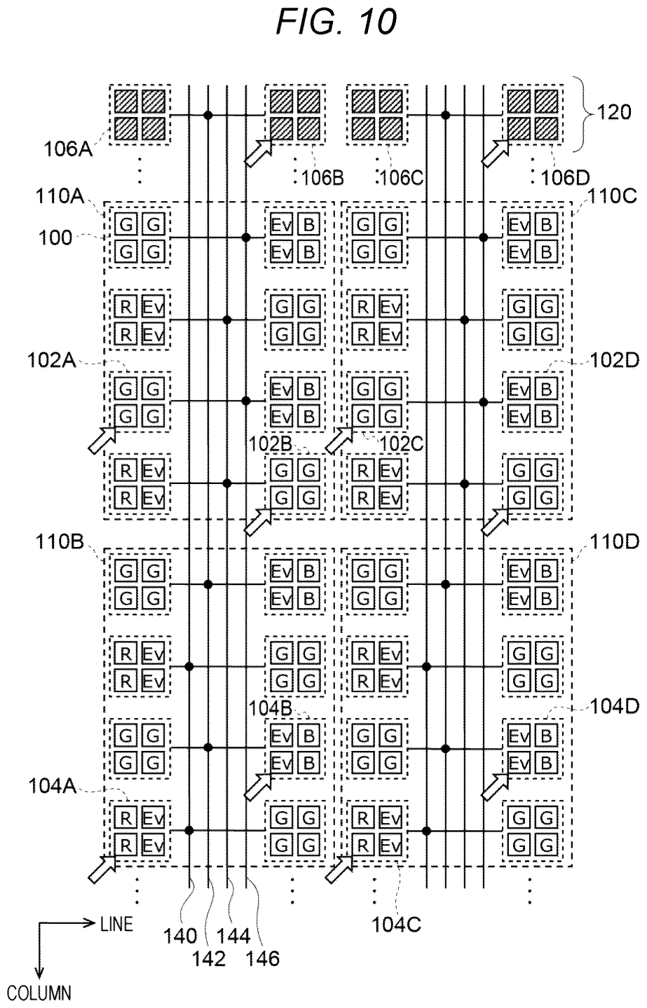

FIG. 10 is a diagram schematically illustrating a connection example between pixels and signal lines according to an embodiment. Signal lines 140, 142, 144, and 146 are signal lines common to unit pixel groups belonging to the same column. A signal output from each pixel, more specifically each sub-pixel, is transmitted to the read circuit through any one of the signal lines.

For example, at the timing of outputting a signal using the lower right sub-pixel of the pixel 100, a signal from a sub-pixel indicated by an arrow is output through any one of the signal lines 140, 142, 144, and 146.

As an example, signals are output at the same timing from two pixels of the unit pixel groups belonging to cyclically adjacent lines. With such a configuration, it is possible to output signals using two signal lines for the unit pixel group. The adjacent lines are connected to different signal lines. Unit pixel groups contiguous along a column may cause sub-pixels to output signals using signal lines different from the above-described two signal lines.

For example, the pixel 100 of the unit pixel group in the upper part of the drawing is connected to any one of the signal lines 144 and 146, and the pixel 100 of the unit pixel group in the lower part of the drawing is connected to any one of the signal lines 140 and 142.

Note that, for the light shielding pixels 106 belonging to the second dummy region 122 and the third dummy region 124, signal lines dedicated to the light shielding pixels 106 may be separately provided by general connection, or the signal value of the light shielding pixel may be output using the signal line 140 or the like by any general method.

FIG. 10 illustrates two columns and four unit pixel groups 110A, 110B, 110C, and 110D. At certain timing, gradation pixels 102A and 102B of the unit pixel group 110A, event detection pixels 104A and 104B of the unit pixel group 110B, gradation pixels 102C and 102D of the unit pixel group 110A, and event detection pixels 104C and 104D of the unit pixel group 110D are selected, and moreover, each pixel is controlled to output a signal from a sub-pixel located at the lower left.

For each unit pixel group, light shielding pixels 106A, 106B, 106C, and 106D belonging to the dummy region are provided in the same column on the edge of the pixel array 10. Similarly, the lower left sub-light shielding pixel of the light shielding pixel 106 belonging to any line is connected to any signal line belonging to the column. The connection between the light shielding pixel 106 and the signal line may be switchable. In other words, for example, the light shielding pixel 106B may be controlled to selectively connect to any one of the signal lines 140, 142, 144, and 146 according to timing.

With the above-described configuration, a connection example of the signal lines will be described. As an example, for the selected gradation pixels 102A and 102B, signals are output from the sub-pixels located at the lower left through the signal lines 146 and 144, respectively. Similarly, for the selected event detection pixels 104A and 104B, signals are output from the sub-pixels located at the lower left via the signal lines 140 and 142, respectively.

The gradation pixels 102A and 102B and the event detection pixel 104A output gradation signals, and the event detection pixel 104B outputs event detection information. With this configuration, the light shielding pixel 106B may be connected to the signal line 142 through which the event detection information is output. With such connection, it is possible to output the influence of the interference between the event detection pixel and the signal line, that is, the influence of the interference of the signal value for each column with the output from the light shielding pixel 106 and the gradation signal prevented from being mixed.

In general, the cycle of acquiring the event detection information is much shorter than the cycle of acquiring the gradation information. Therefore, there is no particular problem even if the same signal line as of the pixel from which the event detection information is acquired is used for the data of the light shielding pixel 106 at the timing when the event information is not acquired. Furthermore, in a case where an event is detected, it is possible to acquire, by outputting the event detection information using the same signal line as of the output of the light shielding pixel 106, information regarding the position to which the signal line through which the signal value of the light shielding pixel 106 is output belongs and that may suffer interference with the signal value due to the event detection.

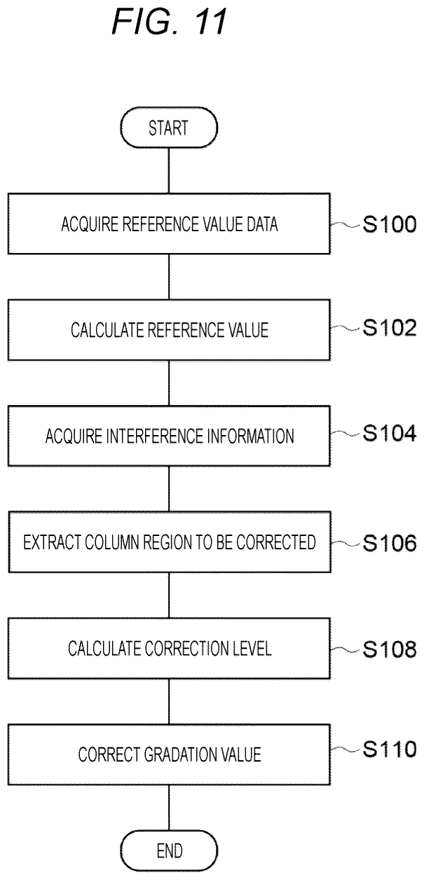

The first signal processing circuit 18 illustrated in FIG. 2 corrects the signal value output from each sub-gradation pixel 1020 on the basis of the flowchart illustrated in FIG. 11.

First, the first signal processing circuit 18 acquires reference value data (S100). The reference value data is, for example, data used to calculate a reference value used to remove thermal noise or the like for correction. The reference value data can be acquired on the basis of, for example, the output from the light shielding pixels 106 belonging to the second dummy region 122. As another example, the reference value data can be acquired on the basis of the output from the light shielding pixels 106 belonging to the third dummy region 124. It is possible to acquire, by making the pixels shielded from light in the second dummy region 122 and the third dummy region 124 similar in configuration to the pixel in the light receiving region, the reference value data having characteristics closer to the light receiving region.

Next, the first signal processing circuit 18 calculates a reference value from the reference value data (S102). For example, the first signal processing circuit 18 calculates the reference value by calculating an average value of the output data of the light shielding pixels 106 in a line acquired in S100 or the output data of the light shielding pixels 106 belonging to the second dummy region 122 in a column. The processing in this step is similar to processing for the configuration including general optical black in the line direction and the column direction, so that any desired method for acquiring a correction value (corresponding to the reference value) from the optical black may be used.

Next, the first signal processing circuit 18 acquires interference information (S104). The interference information may be light shielding pixel data that is output from the light shielding pixels 106 belonging to the first dummy region 120.

Next, the first signal processing circuit 18 extracts a column region to be corrected (S106). The first signal processing circuit 18 extracts the correction region on the basis of the light shielding pixel data acquired from the first dummy region 120 in S104. For example, the first signal processing circuit 18 compares the reference value calculated in S102 with the light shielding pixel data acquired in S104 for a line being scanned, and determines and extracts a region where the light shielding pixel data exceeds the reference value as a region where interference has Occurred.

Next, the first signal processing circuit 18 calculates a correction level for the correction region acquired in S106 (S108). For example, the first signal processing circuit 18 may use a difference between the light shielding pixel data acquired for each column and the reference value as the correction value. As another example, the first signal processing circuit 18 may use a difference between the average value of the light shielding pixel data in the correction region and the reference value as the correction value.

Next, the first signal processing circuit 18 corrects a gradation value of each pixel in the region acquired in S106 with the correction value acquired in S108 (S110). Note that, in a manner similar to this correction, the first signal processing circuit 18 may also perform correction of thermal noise or the like in the correction region and other regions on the basis of data acquired from the second dummy region and/or the third dummy region 124.

Note that the above-described processing can be replaced as desired within a range not affecting the calculation result.

As described above, the sensor device according to the present embodiment can appropriately extract, by using the light shielding pixel having the same output path as of the event detection pixel, a state of interference with a signal line due to the output of the event detection pixel and appropriately correct a gradation value for the region where the interference has occurred.

Hereinafter, a connection relationship between pixels and signal lines will be described with some examples.

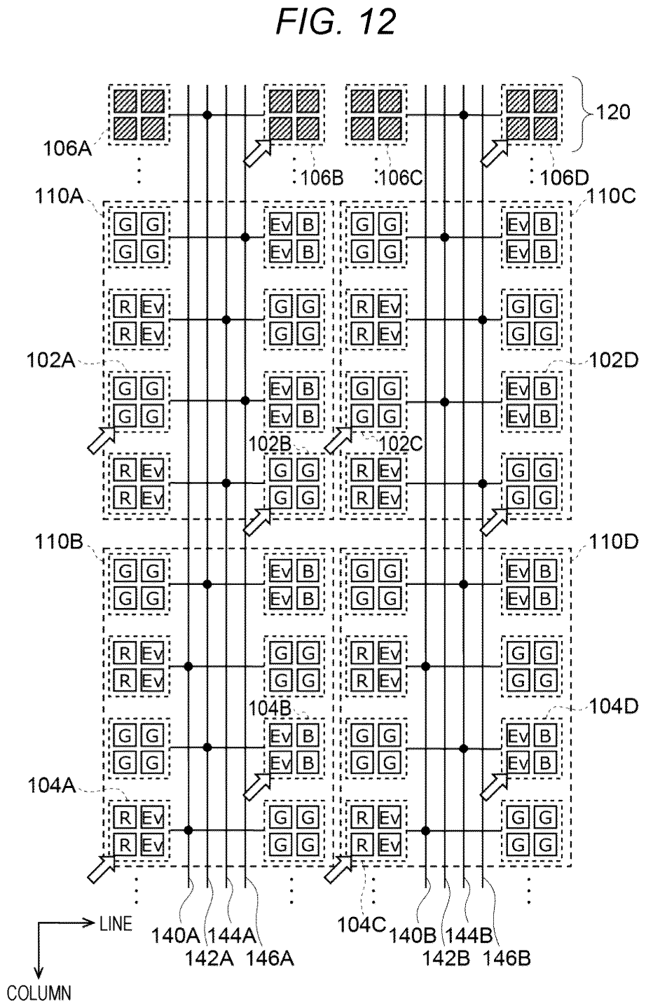

FIG. 12 is a diagram illustrating a connection example between pixels and signal lines according to an embodiment. In FIG. 10, the unit pixel groups provided along a line have the same relative connection relationship between the plurality of signal lines and the pixels. The aspects of the present disclosure, however, are not limited thereto.

As illustrated in FIG. 12, connection states between pixels and signal lines in the unit pixel groups 110 A and 110B and the unit pixel groups 110 C and 110D may be different.

Specifically, the gradation pixel 102A of the unit pixel group 110A and the gradation pixel 102C of the unit pixel portion 110C, both belonging to the same relative position, may be connected to signal lines arranged at different relative positions. For example, the gradation pixel 102A is connected to the third signal line 144A from the left among the column signal lines to which the unit pixel group 110A belongs. On the other hand, the gradation pixel 102C may be connected to the fourth signal line 146B from the left among the column signal lines to which the unit pixel group 110C belongs.

As for the column direction, the connection relationship is maintained as in FIG. 10. It is needless to say that there is a possibility that the relative positions of the signal lines connected with the sub-event detection pixels of the event detection pixels 104B and 104C responsible for event detection also change.

In this case, as illustrated in FIG. 12, the connection status of the light shielding pixels 106 belonging to the first dummy region 120 also changes as appropriate. For example, the light shielding pixel 106B is connected to the same signal line 142A as of the event detection pixel 104B responsible for event detection of the unit pixel group belonging to the same column, while the light shielding pixel 106D is connected to the same signal line 144B as of the event detection pixel 104D responsible for event detection of the unit pixel group belonging to the same column, so that the relative position relationship between the signal lines in the columns becomes different.

According to the aspect illustrated in FIG. 12, in a case where the interference amount differs in a manner that depends on the position of wiring of a signal line, it is possible to achieve more accurate extraction of a buffer region.

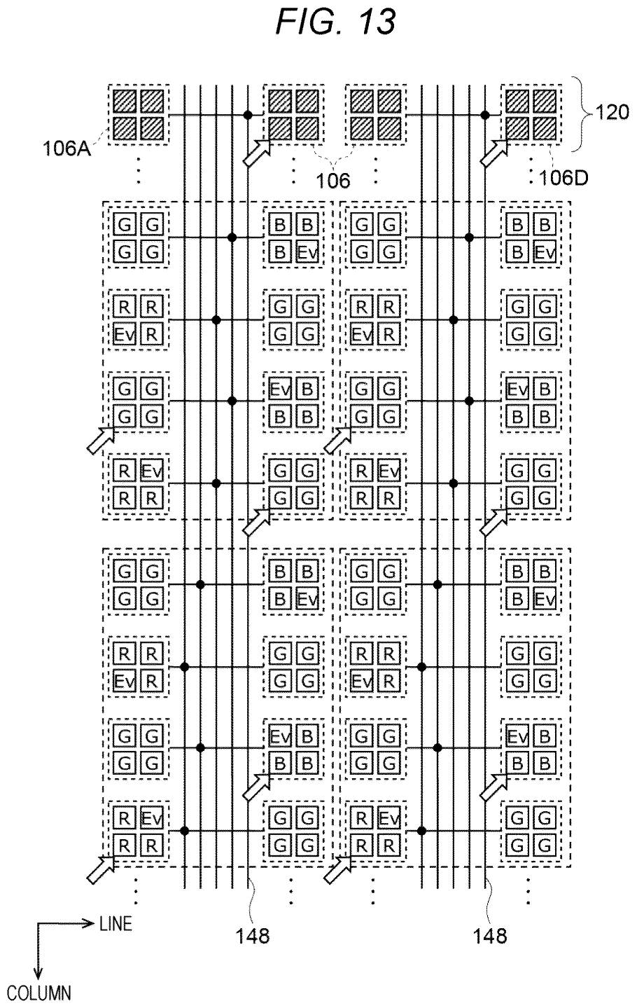

FIG. 13 is a diagram illustrating a connection example between pixels and signal lines according to an embodiment. The sensor device 1 may include signal lines 148 dedicated to the light shielding pixels 106 belonging to the first dummy region 120 in the column for each unit pixel group.

In the pixel array 10, in a case where the density of the sub-event detection pixels is sparse, and the R, G, and B signal values can be acquired at the same timing, the connection of the signal lines in the above-described form has a possibility that a signal line indicating any gradation value and the light shielding pixel 106 belonging to the first dummy region 120 are connected to the same signal line, which prevents an appropriate gradation value from being acquired.

In this case, as illustrated in FIG. 13, it is possible to acquire, by providing the signal lines 148 connected only to the light shielding regions 106 of the first dummy region 120, gradation information with higher accuracy.

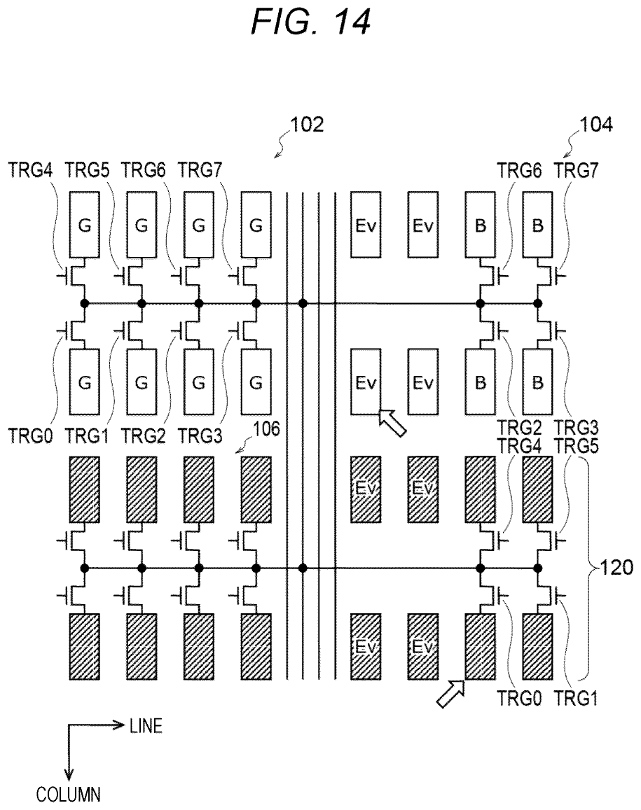

FIG. 14 is a diagram illustrating examples of the gradation pixel 102, the event detection pixel 104, and the light shielding pixel 106 in the first dummy region 120 according to an embodiment. As illustrated in this drawing, for example, the light shielding pixel 106 may correspond to a light receiving element that is similar in arrangement to the gradation pixel 102 and the event detection pixel 104 and has the light receiving surface shielded from light. The diagonal lines indicate sub-pixels shielded from light.

In this case, in both of the gradation pixel 102 and the event detection pixel 104, trigger signals TRG0 to TRG7 are appropriately controlled to drive sub-pixels located at the same relative position in the pixels.

For example, in a case where a sub-event detection pixel indicated by an arrow is brought into an event detection standby state, the corresponding trigger signal TRG0 and the sub-light shielding pixel indicated by an arrow are driven, and an interference region can be acquired using the output from the sub-light shielding pixel.

On the other hand, in order to appropriately select the sub-light shielding pixel connected to the sub-event detection pixel, a sub-light shielding pixel may be provided in the light shielding pixel 106 to exclusively connect to the trigger signals TRG2, TRG3, TRG6, and TRG7. With this configuration, in a case where the sub-event detection pixel is selected by the trigger signal, the sub-light shielding pixel of the light shielding pixel 106 in the first dummy region 120 and the sub-event detection pixel can be appropriately connected.

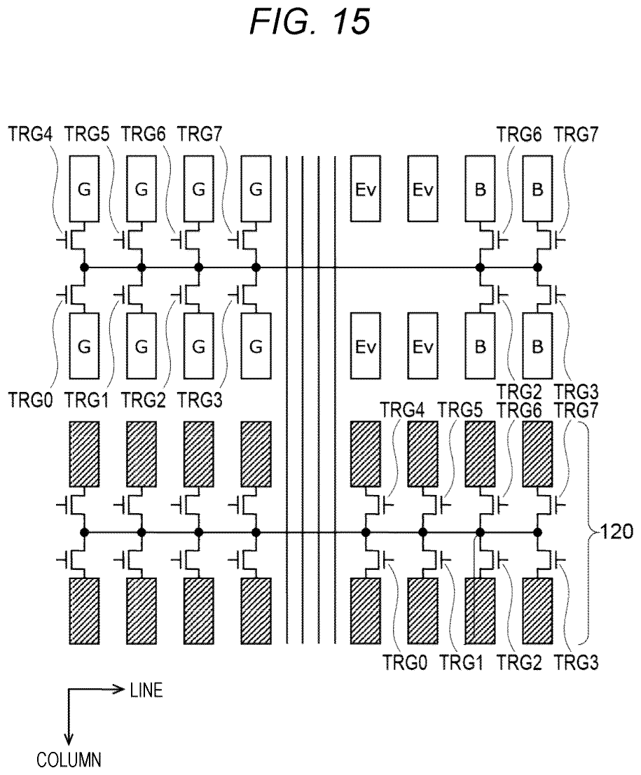

FIG. 15 is a diagram illustrating another example. In this drawing, the light shielding pixel 106 in the first dummy region 120 may correspond to a gradation pixel 102 having the light receiving surface shielded from light. In this case, it is possible to appropriately connect, by driving the sub-light shielding pixel corresponding to each trigger signal, the sub-event detection pixel and the sub-light shielding pixel.

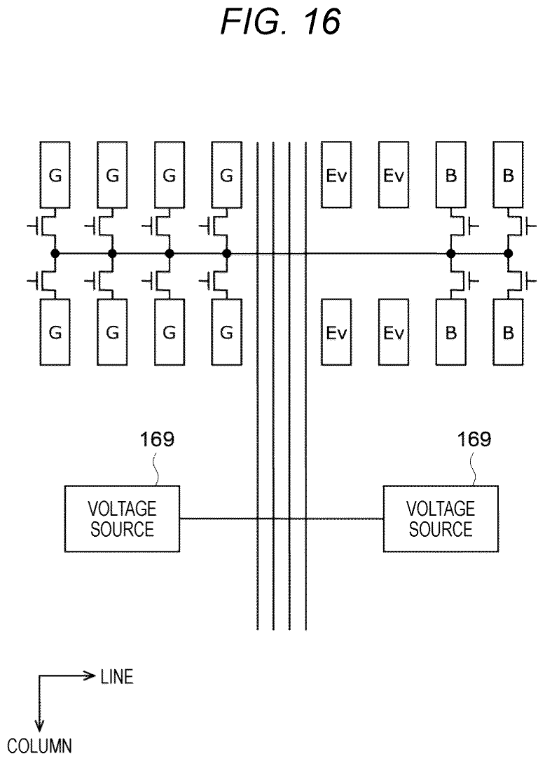

FIG. 16 is a diagram illustrating another example. In the first dummy region 120, an analog voltage source 169 can be used instead of the light shielding pixel.

The technology according to the present disclosure can be applied to various products. For example, the technology according to the present disclosure may also be implemented as a device mounted on any kind of mobile body such as an automobile, an electric automobile, a hybrid electric automobile, a motorcycle, a bicycle, a personal mobility, an airplane, a drone, a ship, a robot, a construction machine, an agricultural machine (tractor), or the like.

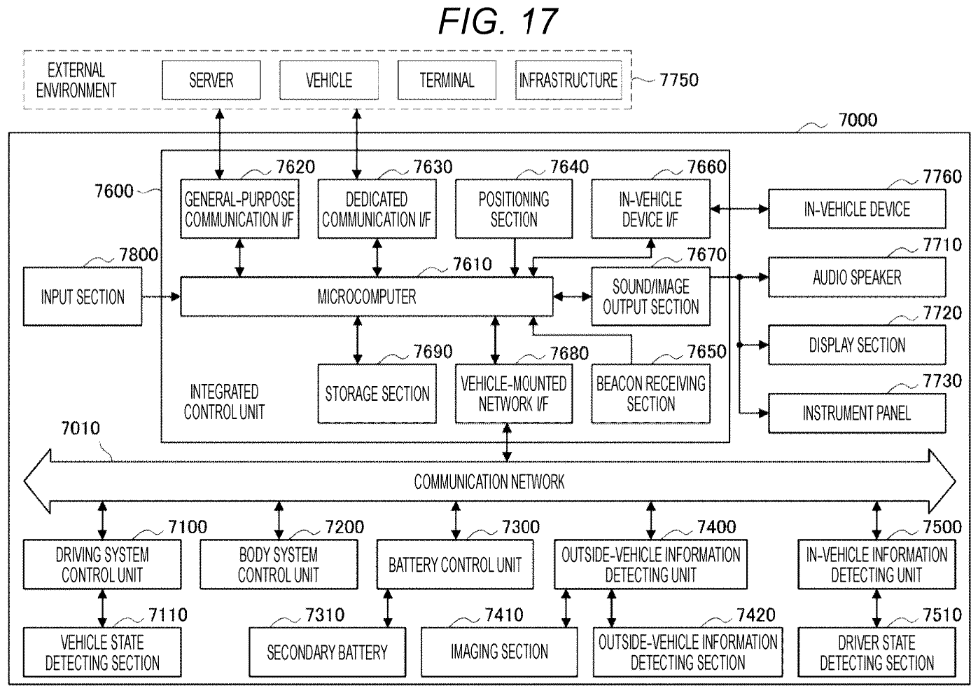

FIG. 17 is a block diagram illustrating a schematic configuration example of a vehicle control system 7000 as an example of a mobile body control system to which the technology of the present disclosure is applied. The vehicle control system 7000 includes a plurality of electronic control units connected to each other via a communication network 7010. In the example illustrated in FIG. 17, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units may be, for example, a vehicle-mounted communication network conforming to any standard such as a controller area network (CAN), a local interconnect network (LIN), a local area network (LAN), or FlexRay (registered trademark).

Each control unit includes a microcomputer that performs arithmetic processing in accordance with various kinds of programs, a storage section that stores the programs executed by the microcomputer, parameters used for various arithmetic operations and the like, and a driving circuit that drives various devices to be controlled. Each control unit includes a network I/F for performing communication with the other control units via the communication network 7010, and includes a communication I/F for performing communication with devices, sensors, or the like inside and outside a vehicle by wired or wireless communication. A functional configuration of the integrated control unit 7600 illustrated in FIG. 17 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine or a driving motor, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device such as an antilock brake system (ABS) or an electronic stability control (ESC).

The driving system control unit 7100 is connected with a vehicle state detecting section 7110. The vehicle state detecting section 7110 includes, for example, at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided for the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, a state of charge of the battery, or the like from a battery device including the secondary battery 7310. The battery control unit 7300 performs arithmetic processing using these signals to regulate the temperature of the secondary battery 7310 or control a cooling device provided for the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 or an outside-vehicle information detecting section 7420. The imaging section 7410 includes at least one of a time-of-flight (ToF) camera, a stereo camera, a monocular camera, an infrared camera, or another camera. The outside-vehicle information detecting section 7420 includes, for example, at least one of an environmental sensor for detecting current weather conditions or meteorological conditions, or a surrounding information detecting sensor for detecting another vehicle, an obstacle, a pedestrian, or the like around the vehicle including the vehicle control system 7000.

The environmental sensor may include, for example, at least one of a raindrop sensor that detects rain, a fog sensor that detects a fog, a sunshine sensor that detects a degree of sunshine, or a snow sensor that detects a snowfall. The surrounding information detecting sensor may include at least one of an ultrasonic sensor, a radar device, or a LIDAR device (Light detection and Ranging device, or Laser imaging detection and ranging device). The imaging section 7410 and the outside-vehicle information detecting section 7420 may be provided as independent sensors or devices, or may be provided as devices in which a plurality of sensors or devices is integrated.

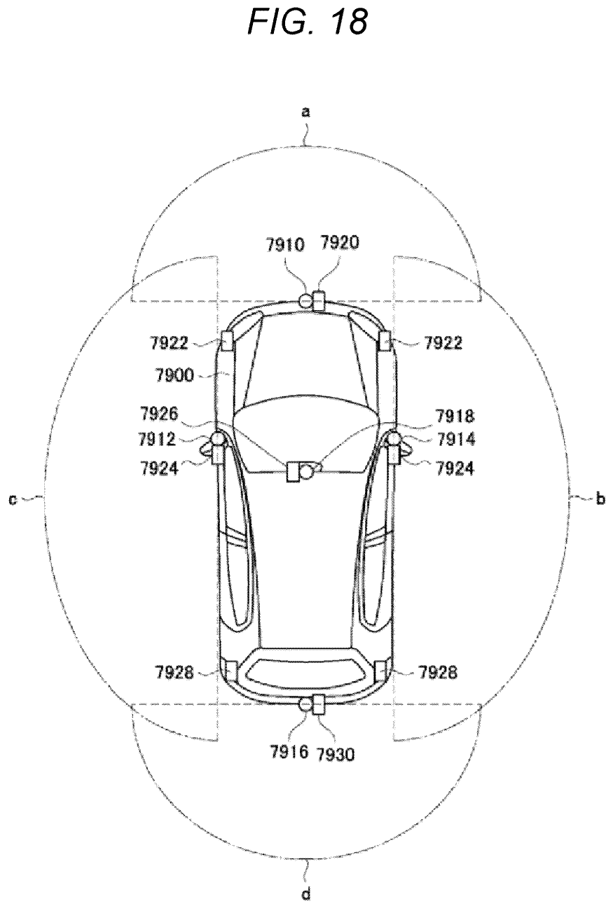

Here, FIG. 18 illustrates an example of installation positions of the imaging section 7410 and the outside-vehicle information detecting section 7420. Imaging sections 7910, 7912, 7914, 7916, and 7918 are, for example, provided at at least one of positions including a front nose, sideview mirrors, a rear bumper, and a back door of a vehicle 7900, and an upper portion of a windshield in the vehicle. The imaging section 7910 provided at the front nose and the imaging section 7918 provided at the upper portion of the windshield in the vehicle capture mainly images of the front of the vehicle 7900. The imaging sections 7912 and 7914 provided at the sideview mirrors capture mainly images of the sides of the vehicle 7900. The imaging section 7916 provided at the rear bumper or the back door captures mainly an image of the rear of the vehicle 7900. The imaging section 7918 provided at the upper portion of the windshield in the vehicle is used mainly to detect a preceding vehicle, a pedestrian, an obstacle, a signal, a traffic sign, a lane, or the like.

Note that FIG. 18 illustrates an example of the imaging range of each of the imaging sections 7910, 7912, 7914, and 7916. An imaging range a represents the imaging range of the imaging section 7910 provided at the front nose, imaging ranges b and c respectively represent the imaging ranges of the imaging sections 7912 and 7914 provided at the sideview mirrors, an imaging range d represents the imaging range of the imaging section 7916 provided at the rear bumper or the back door. A bird's-eye image of the vehicle 7900 as viewed from above can be obtained by superimposing image data captured by the imaging sections 7910, 7912, 7914, and 7916, for example.

Outside-vehicle information detecting sections 7920, 7922, 7924, 7926, 7928, and 7930 provided at the front, rear, sides, and corners of the vehicle 7900 and the upper portion of the windshield in the vehicle may include, for example, an ultrasonic sensor or a radar device. The outside-vehicle information detecting sections 7920, 7926, and 7930 provided at the front nose, the rear bumper, and the back door of the vehicle 7900, and the upper portion of the windshield in the vehicle may each include a LIDAR device, for example. These outside-vehicle information detecting sections 7920 to 7930 are used mainly to detect a preceding vehicle, a pedestrian, an obstacle, or the like.

Referring back to FIG. 17, the description will be continued. The outside-vehicle information detecting unit 7400 causes the imaging section 7410 to capture an image of the outside of the vehicle, and receives captured image data. Furthermore, the outside-vehicle information detecting unit 7400 receives detection information from the outside-vehicle information detecting section 7420 connected to the outside-vehicle information detecting unit 7400. In a case where the outside-vehicle information detecting section 7420 includes an ultrasonic sensor, a radar device, or a LIDAR device, the outside-vehicle information detecting unit 7400 transmits an ultrasonic wave, an electromagnetic wave, or the like, and receives information regarding a received reflected wave. The outside-vehicle information detecting unit 7400 may perform, on the basis of the received information, processing of detecting an object such as a human, a vehicle, an obstacle, a sign, or a character on a road surface, or processing of detecting a distance to the object. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

Furthermore, the outside-vehicle information detecting unit 7400 may perform, on the basis of the received image data, image recognition processing of recognizing an object such as a human, a vehicle, an obstacle, a sign, or a character on a road surface, or processing of detecting a distance to the object. The outside-vehicle information detecting unit 7400 may subject the received image data to processing such as distortion correction, alignment, or the like, and combine the image data captured by different imaging sections 7410 to generate a bird's-eye image or a panoramic image. The outside-vehicle information detecting unit 7400 may perform viewpoint conversion processing using the image data captured by different imaging sections 7410.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that captures an image of the driver, a biological sensor that detects biological information of the driver, a microphone that collects sound in the vehicle, or the like. The biological sensor is provided on, for example, the seat surface, the steering wheel, or the like, and detects biological information of an occupant sitting on the seat or the driver holding the steering wheel. The in-vehicle information detecting unit 7500 may calculate, on the basis of detection information input from the driver state detecting section 7510, a degree of fatigue of the driver or a degree of concentration of the driver, or may determine whether or not the driver is dozing. The in-vehicle information detecting unit 7500 may subject a collected sound signal to processing such as a noise canceling processing or the like.

The integrated control unit 7600 controls general operation in the vehicle control system 7000 in accordance with various kinds of programs. The integrated control unit 7600 is connected with an input section 7800. The input section 7800 is implemented by a device that can be operated by an occupant for input, such as a touch panel, a button, a microphone, a switch, or a lever. The integrated control unit 7600 may be supplied with data obtained by voice recognition of voice input through the microphone. The input section 7800 may include, for example, a remote control device using infrared rays or other radio waves, or an external connecting device such as a mobile phone, a personal digital assistant (PDA), or the like compatible with the vehicle control system 7000. The input section 7800 may include, for example, a camera, and in this case, an occupant can input information by gesture. Alternatively, data obtained by detecting the movement of a wearable device that an occupant wears may be input. Moreover, the input section 7800 may include, for example, an input control circuit or the like that generates an input signal on the basis of information input by an occupant or the like using the above-described input section 7800, and outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. Furthermore, the storage section 7690 may be implemented by a magnetic storage device such as a hard disc drive (HDD), a semiconductor storage device, an optical storage device, a magneto-optical storage device, or the like.

The general-purpose communication I/F 7620 is a general-purpose communication I/F that mediates communication with various apparatuses present in an external environment 7750. The general-purpose communication I/F 7620 may have implemented therein a cellular communication protocol such as global system of mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may connect to an apparatus (for example, an application server or a control server) present on an external network (for example, the Internet, a cloud network, or a company-specific network) via a base station or an access point, for example. Furthermore, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may have implemented therein a standard protocol such wireless access in vehicle environment (WAVE), which is a combination of IEEE 802.11p as a lower layer and IEE17609 as a higher layer, dedicated short range communications (DSRC), or a cellular communication protocol, for example. The dedicated communication I/F 7630 typically performs V2X communication that is a concept including one or more of vehicle-to-vehicle communication, vehicle-to-infrastructure communication, vehicle-to-home communication, and vehicle-to-pedestrian communication.

The positioning section 7640 receives a global navigation satellite system (GNSS) signal from a GNSS satellite (for example, a global positioning system (GPS) signal from a GPS satellite) to perform positioning, and generates positional information including the latitude, longitude, and altitude of the vehicle, for example. Note that the positioning section 7640 may identify the current position by exchanging signals with a wireless access point, or may obtain the positional information from a terminal such as a mobile phone, a personal handyphone system (PHS) terminal, or a smartphone that has a positioning function.

The beacon receiving section 7650 receives a radio wave or an electromagnetic wave transmitted from a wireless station installed on a road or the like to obtain information about the current position, congestion, a closed road, a travel time, or the like, for example. Note that the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present in the vehicle. The in-vehicle device I/F 7660 may establish wireless connection using a wireless communication protocol such as wireless LAN, Bluetooth (registered trademark), near field communication (NFC), or wireless universal serial bus (WUSB). Furthermore, the in-vehicle device I/F 7660 may establish wired connection such as universal serial bus (USB), high-definition multimedia interface (HDMI (registered trademark)), mobile high-definition link (MHL) or the like via a connection terminal (and a cable if necessary) not illustrated. The in-vehicle devices 7760 may include, for example, at least one of a mobile device or a wearable device which an occupant has, or an information device carried in or attached to the vehicle. Furthermore, the in-vehicle devices 7760 may include a navigation device that searches for a route to any desired destination. The in-vehicle devices I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like according to a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, or the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS), the functions including vehicle collision avoidance or shock mitigation, follow-up traveling based on an inter-vehicle distance, adaptive cruise control, vehicle collision warning, vehicle lane departure warning, and the like. Furthermore, the microcomputer 7610 may perform cooperative control intended for automated driving, which causes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, or the vehicle-mounted network I/F 7680. Furthermore, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound or an image to an output device capable of visually or auditorily giving information to an occupant of the vehicle or the outside of the vehicle. In the example in FIG. 17, an audio speaker 7710, a display section 7720, and an instrument panel 7730 are illustrated as the output device. The display section 7720 may include, for example, at least one of an on-board display or a head-up display. The display section 7720 may have an augmented reality (AR) display function. The output device may include, other than the above-described devices, another device such as headphones, a wearable device such as an eyeglass-type display worn by an occupant, a projector, or a lamp. In a case where the output device is a display device, the display device visually displays results obtained by various kinds of processing performed by the microcomputer 7610 or information received from another control unit in various forms such as text, an image, a table, or a graph. Furthermore, in a case where the output device is a sound output device, the sound output device converts an audio signal including reproduced audio data, sound data, or the like into an analog signal, and auditorily outputs the analog signal.

Note that, in the example illustrated in FIG. 17, at least two control units connected over the communication network 7010 may be integrated as one control unit. Alternatively, each individual control unit may include a plurality of control units. Moreover, the vehicle control system 7000 may include another control unit (not illustrated). Furthermore, some or all of the functions performed by any one of the control units in the above description may be assigned to another control unit. That is, predetermined arithmetic processing may be performed by any one of the control units as long as information is transmitted and received via the communication network 7010. Similarly, a sensor or a device connected to any one of the control units may be connected to another control unit, and a plurality of control units may mutually transmit and receive detection information via the communication network 7010.

The embodiments described above may have the following modes.

(1)

A sensor device including a pixel array, in which
the pixel array includes:
a dummy pixel that does not receive incident light;
a gradation pixel including a sub-gradation pixel that receives incident light to acquire gradation information; and
an event detection pixel including the sub-gradation pixel and a sub-event detection pixel that detects a change in the gradation information acquired by receiving incident light, the dummy pixel, the gradation pixel, and the event detection pixel being arranged in an array in a line direction and a column direction, and
a signal is acquired by accessing simultaneously the sub-gradation pixel and the dummy pixel belonging to a line different from a line to which the sub-gradation pixel belongs.

(2)

The sensor device according to (1), in which
the pixel array includes:
a first dummy region in which the dummy pixel is arranged; and
a light receiving region in which the gradation pixel and the event detection pixel are arranged.

(3)

The sensor device according to (2), in which
the dummy pixel includes a light shielding pixel corresponding to the gradation pixel having a light receiving surface shielded from light or the event detection pixel having a light receiving surface shielded from light.

(4)

The sensor device according to (2) or (3), in which
the first dummy region is provided on an edge of the pixel array at least along the line direction.

(5)

The sensor device according to (4), in which
the dummy pixel arranged in the first dummy region and the event detection sub-pixel belonging to the light receiving region perform output for each column through the same signal line.

(6)

The sensor device according to (5), in which
the dummy pixel includes a pixel that is arranged in the first dummy region in an arrangement configuration different from an arrangement configuration of the gradation pixel and the event detection pixel in the light receiving region and is shielded from light.

(7)

The sensor device according to (6), in which
the dummy pixel does not include a sub-pixel corresponding to the sub-event detection pixel of the event detection pixel shielded from light.

(8)

The sensor device according to (6), in which
the pixel array includes a plurality of the gradation pixels and a plurality of the event detection pixels, which sub-pixel of each of the pixels acquires and outputs a signal is switched in response to a trigger signal, and
no connection is established to the dummy pixel corresponding to the sub-event detection pixel shielded from light in response to the trigger signal.

(9)

The sensor device according to any one of (3) to (8), further including a plurality of column signal lines through which a signal output from a pixel belonging to one of the columns propagates, in which
one of the plurality of column signal lines is connected exclusively to the dummy pixel.

(10)

The sensor device according to any one of (3) to (8), further including, in a unit pixel group including two pixels arranged contiguous in the line direction and a plurality of pixels arranged contiguous in the column direction, a plurality of column signal lines through which a signal output from the unit pixel group belonging to the column direction propagates, in which
pixels that belong to the same line and are identical in position in the unit pixel group are connected to the column signal lines provided at the same relative position among the plurality of column signal lines.

(11)

The sensor device according to any one of (3) to (8), further including, in a unit pixel group including two pixels arranged contiguous in the line direction and a plurality of pixels arranged contiguous in the column direction, a plurality of column signal lines through which a signal output from the unit pixel group belonging to the column direction propagates, in which
pixels that belong to the same line and are identical in position in the unit pixel group are connected to the column signal lines provided at different relative positions among the plurality of column signal lines.

(12)

The sensor device according to (10) or (11), in which
the unit pixel group includes eight pixels, the eight pixels including:
two pixels arranged contiguous in the line direction; and
four pixels arranged contiguous in the column direction.

(13)

The sensor device according to (4), further including, in the line different from the first dummy region on the edge of the pixel array, a second dummy region including the dummy pixel corresponding to a pixel that is identical in configuration to a line in the light receiving region and is shielded from light, in which
a reference value used to correct a signal value output from a pixel belonging to the light receiving region is calculated from a signal value output from the dummy pixel belonging to the second dummy region.

(14)

The sensor device according to (13), in which
a signal value output from the first dummy region is compared with the reference value, and a correction region corresponding to a pixel region for which a signal value output from the light receiving region is corrected is acquired.

(15)

The sensor device according to (14), in which
gradation information in the correction region is corrected on the basis of the signal value output from the first dummy region.

(16)

The sensor device according to (4) or (13), further including a third dummy region in which the dummy pixel is provided on the edge of the pixel array along the column direction so as not to overlap the first dummy region, in which
a reference value used to correct a signal value output from a pixel belonging to the light receiving region is calculated from a signal value output from the dummy pixel belonging to the third dummy region.

(17)

The sensor device according to (16), in which
a signal value output from the first dummy region is compared with the reference value, and a correction region corresponding to a pixel region for which a signal value output from the light receiving region is corrected is acquired.

(18)

The sensor device according to (17), in which
gradation information in the correction region is corrected on the basis of the signal value output from the first dummy region.

(19)

The sensor device according to (2), in which
the dummy pixel includes an analog dummy pixel that outputs a predetermined analog voltage.

Aspects of the present disclosure are not limited to the above-described embodiments, and include various conceivable modifications. The effects of the present disclosure are not limited to the above-described contents. The components in each of the embodiments may be appropriately combined and applied. That is, various additions, modifications, and partial deletions can be made without departing from the conceptual idea and gist of the present disclosure derived from the contents defined in the claims and equivalents and the like thereof.

### REFERENCE SIGNS LIST

1 SENSOR DEVICE
10 Pixel array
100 Pixel
1020 Sub-gradation pixel
1040 Sub-event detection pixel
102 Gradation pixel
104 Event detection pixel
106 Light shielding pixel
110 Unit pixel group
120 First dummy region
122 Second dummy region
124 Third dummy region
140, 142, 144, 146, 148 Signal line
160 Voltage source
12 Timing control circuit
14 Access control circuit
16 First read circuit
18 First signal processing circuit
20 Second read circuit
22 Second signal processing circuit
24 Time stamp generation circuit
26 Output I/F

1. A sensor device comprising a pixel array, wherein
the pixel array includes:
a dummy pixel that does not receive incident light;
a gradation pixel including a sub-gradation pixel that receives incident light to acquire gradation information; and
an event detection pixel including the sub-gradation pixel and a sub-event detection pixel that detects a change in the gradation information acquired by receiving incident light, the dummy pixel, the gradation pixel, and the event detection pixel being arranged in an array in a line direction and a column direction, and
a signal is acquired by accessing simultaneously the sub-gradation pixel and the dummy pixel belonging to a line different from a line to which the sub-gradation pixel belongs.

2. The sensor device according to claim 1, wherein
the pixel array includes:
a first dummy region in which the dummy pixel is arranged; and
a light receiving region in which the gradation pixel and the event detection pixel are arranged.

3. The sensor device according to claim 2, wherein
the dummy pixel includes a light shielding pixel corresponding to the gradation pixel having a light receiving surface shielded from light or the event detection pixel having a light receiving surface shielded from light.

4. The sensor device according to claim 2, wherein
the first dummy region is provided on an edge of the pixel array at least along the line direction.

5. The sensor device according to claim 4, wherein
the dummy pixel arranged in the first dummy region and the event detection sub-pixel belonging to the light receiving region perform output for each column through a same signal line.

6. The sensor device according to claim 5, wherein
the dummy pixel includes a pixel that is arranged in the first dummy region in an arrangement configuration different from an arrangement configuration of the gradation pixel and the event detection pixel in the light receiving region and is shielded from light.

7. The sensor device according to claim 6, wherein
the dummy pixel does not include a sub-pixel corresponding to the sub-event detection pixel of the event detection pixel shielded from light.

8. The sensor device according to claim 6, wherein
the pixel array includes a plurality of the gradation pixels and a plurality of the event detection pixels, which sub-pixel of each of the pixels acquires and outputs a signal is switched in response to a trigger signal, and
no connection is established to the dummy pixel corresponding to the sub-event detection pixel shielded from light in response to the trigger signal.

9. The sensor device according to claim 3, further comprising a plurality of column signal lines through which a signal output from a pixel belonging to one of the columns propagates, wherein
one of the plurality of column signal lines is connected exclusively to the dummy pixel.

10. The sensor device according to claim 3, further comprising, in a unit pixel group including two pixels arranged contiguous in the line direction and a plurality of pixels arranged contiguous in the column direction, a plurality of column signal lines through which a signal output from the unit pixel group belonging to the column direction propagates, wherein
pixels that belong to the same line and are identical in position in the unit pixel group are connected to the column signal lines provided at a same relative position among the plurality of column signal lines.

11. The sensor device according to claim 3, further comprising, in a unit pixel group including two pixels arranged contiguous in the line direction and a plurality of pixels arranged contiguous in the column direction, a plurality of column signal lines through which a signal output from the unit pixel group belonging to the column direction propagates, wherein
pixels that belong to the same line and are identical in position in the unit pixel group are connected to the column signal lines provided at different relative positions among the plurality of column signal lines.

12. The sensor device according to claim 10, wherein
the unit pixel group includes eight pixels, the eight pixels including:
two pixels arranged contiguous in the line direction; and
four pixels arranged contiguous in the column direction.

13. The sensor device according to claim 4, further comprising, in the line different from the first dummy region on the edge of the pixel array, a second dummy region including the dummy pixel corresponding to a pixel that is identical in configuration to a line in the light receiving region and is shielded from light, wherein
a reference value used to correct a signal value output from a pixel belonging to the light receiving region is calculated from a signal value output from the dummy pixel belonging to the second dummy region.

14. The sensor device according to claim 13, wherein
a signal value output from the first dummy region is compared with the reference value, and a correction region corresponding to a pixel region for which a signal value output from the light receiving region is corrected is acquired.

15. The sensor device according to claim 14, wherein
gradation information in the correction region is corrected on a basis of the signal value output from the first dummy region.

16. The sensor device according to claim 4, further comprising a third dummy region in which the dummy pixel is provided on the edge of the pixel array along the column direction so as not to overlap the first dummy region, wherein
a reference value used to correct a signal value output from a pixel belonging to the light receiving region is calculated from a signal value output from the dummy pixel belonging to the third dummy region.

17. The sensor device according to claim 16, wherein
a signal value output from the first dummy region is compared with the reference value, and a correction region corresponding to a pixel region for which a signal value output from the light receiving region is corrected is acquired.

18. The sensor device according to claim 17, wherein
gradation information in the correction region is corrected on a basis of the signal value output from the first dummy region.

19. The sensor device according to claim 2, wherein
the dummy pixel includes an analog dummy pixel that outputs a predetermined analog voltage.
